(19) United States
(12) Patent Application Publication
(10) Pub. No.: US 2011/0022366 A1
(43) Pub. Date: Jan. 27, 2011

(54) SYSTEMS AND METHODS FOR IDENTIFYING AND UTILIZING A MASS FLOW SPRINKLER COEFFICIENT

(75) Inventor: Jeremiah P. Crocker, North Providence, RI (US)

Correspondence Address: FOR: TYCO FIRE SUPPRESSION & BUILDING PRODUCTS;PERKINS COIE LLP, 607 Fourteenth Street, NW, Washington, DC, 20005-2003, US

(73) Assignee: TYCO FIRE PRODUCTS LP, Lansdale, PA (US)

(21) Appl. No.: 12/922,765

(22) PCT Filed: Mar. 19, 2009
(86) PCT No.: PCT/US2009/037699

§ 371 Date: Sep. 15, 2010

Related U.S. Application Data
(60) Provisional application No. 61/064,698, filed on Mar. 20, 2008.
(60) Provisional application No. 61/129,030, filed on May 30, 2008.

(51) Int. Cl. G06F 17/10; G06F 19/00; G01F 1/34

(52) U.S. Cl. 703/2; 702/45; 702/47

(57) ABSTRACT

Systems and methods for determining, characterizing and/or predicting the impact of a sprinkler discharge spray on a fire induced mass flow through a vent, preferably a doorway, of a compartment. Provided are systems and methods for determining a sprinkler coefficient that characterizes the ability of a sprinkler to reduce a fire induced mass flow from the compartment. The sprinkler coefficient preferably defines a ratio of a mass flow from a compartment, in the absence of a discharging sprinkler, to the mass flow from a compartment, in the presence of a discharging sprinkler. Accordingly, the systems and methods herein provide for the sprinkler coefficient to define a mass flow equation by accounting for the influence of a discharging sprinkler spray and provide for a new fire induced mass flow calculator.

### PRIORITY DATA AND INCORPORATION BY REFERENCE

This application is a 35 U.S.C. §371 application of International Application No. PCT/US2009/037699, filed Mar. 19, 2009, which claims the benefit of priority to U.S. Provisional Patent Application No. 61/064,698 filed Mar. 20, 2008 and U.S. Provisional Patent Application No. 61/129,030, filed May 30, 2008, each of which is incorporated by reference in their entireties.

### TECHNICAL FIELD

This invention relates generally to systems and methods for evaluating the environmental effect of a sprinkler spray acting on a fire. More specifically, systems and methods are provided for evaluating, characterizing and/or quantifying the effect of a sprinkler discharge spray on a fire induced mass flow out of a compartment. In particular, provided is a method of evaluating the fire induced mass flow out of a compartment in the presence of a sprinkler discharge spray within the compartment. Moreover, the systems and methods provide for determining a sprinkler coefficient that quantifies the cooling ability of a sprinkler to convert a fire induced mass flow from a compartment in the presence of the discharge spray of the sprinkler.

### BACKGROUND OF THE INVENTION

Smoke spreads inside a building by traveling through vents, such as windows and doorways. Fire induced mass flow through these vents is a well understood phenomenon. A simple theoretical model based upon buoyancy allows for the prediction of mass flow out of a vent during a fire. A simplified method, developed by H. W. Emmons, exists to predict the mass flow through a vent during a fire. Emmons developed a mathematical model to characterize the mass flow out of a doorway of a compartment in which there is a fire:

$${\dot{m}}_{out} = \frac{2}{3} {C}_{D} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2}$$

### (Known Mass Flow Equation)

The equation and model are based upon the buoyancy differences between a fire compartment and the ambient environment outside of a vent. This equation assumes that there are two stratified layers within the compartment separated by a steep thermal gradient. More specifically, it is believed that this was the first set of equations to predict fire induced flows into and out of a compartment by assuming a two-zone model of hot upper smoke layer, and cold lower layer of incoming air.

The model assumes that the fire results in a stable stratification within the compartment a heated upper gas layer and a cool lower layer. The development of the two layers creates a pressure difference inside the room. The heated gas in the upper layer has a greater pressure than the ambient air outside the room. This pressure difference causes gases to leave the compartment at a rate based on Bernoulli's principle. FIG. 1 schematically illustrates the two-zone model and further graphically illustrates the pressure differences (P) at the doorway, having a height H, for the stratified two zone model. In order to satisfy conservation of mass, air must also be flowing into the compartment, which occurs at the bottom of the doorway. At some height inside the doorway the flow out transitions to flow in, resulting in a location of zero flow. This point is known as the neutral plane and is shown as Z_{N} in FIG. 1. There is a smoke layer interface height shown in this figure, Z_{D}, which is the transition location inside the compartment from the ambient lower layer into the upper gas layer. Accordingly, this work establishes a relationship between a neutral plane in the doorway and the location of the smoke layer interface inside the compartment.

The analytical model has been verified by various researchers, for example, in Steckler et al., “Flow Induced by Fire in a Compartment,” NBSIR 82-2520, National Bureau of Standards, Washington, D.C., (1982), described is an initial study utilizing different sized steady state fires, different vent sizes and various fire locations. Steckler et al. reported consistent results to that of the model. Although the results found were dependent on a discharge coefficient C_{D} to account for losses across the vent. This coefficient, was reported as C_{D}=0.73.

In Nakaya et al., “Doorway Flow Induced by a Propane Fire,” Fire Safety Journal, 10. pp. 185-195 (1986) the reliability of the model's correlation with larger sized fires and a room adjacent to the burn was examined. The experiments conducted during this study also reported results consistent with the model, even when the flow out of the vent poured into an adjacent room rather than an open ambient environment.

Another experimental study focused on the changes to the flow out of a doorway when a door is attached to the frame. This study, described in Clark, L. R., “The Effect of Door Angle on Fire Induced Flow Through a Doorway,” University of Canterbury, Department of Civil Engineering, Christchurch, New Zealand (2002), found that when a door was included during fire tests it altered the doorway flows. The addition of the door changed and decreased mass flows, made the neutral plane vary across the width of the doorway and altered flame behavior. As the angle at which the door was opened increased, these changes were reduced.

It is believed that none of the published reports studied the effect of a spraying sprinkler on vent flows. To date, it is believed that research on the effect of sprinkler spray has been more focused on the direct effects to the fire and to the room of origin, including determination of the cooling effects of sprinklers based off of water droplet size and evaporation; research into the effect of the sprinkler on smoke layer stability in very tall rooms; and interaction of an isolated sprinkler with a two layer compartment model. It is believed that an investigation has not been contemplated to determine the impact of a sprinkler discharge spray on the model and/or the fire induced mass flows through a vent or doorway of the compartment of fire origin.

### SUMMARY OF THE INVENTION

The present invention provide systems and methods for determining, characterizing and/or predicting the impact of a sprinkler discharge spray on a fire induced mass flow through a vent, preferably a doorway, of a compartment. In particular, provided are systems and methods for determining a sprinkler-coefficient that characterizes the ability of a sprinkler to reduce a fire induced mass flow from the compartment. The sprinkler coefficient preferably defines a ratio of a mass flow from a compartment, in the absence of a discharging sprinkler, to the mass flow from the compartment, in the presence of a sprinkler. Moreover, the sprinkler cooling coefficient converts a fire induced mass flow from a compartment to a reduced mass from a compartment that accounts for the presence of a discharging sprinkler spray. Accordingly, the systems and methods herein provide for the sprinkler-coefficient which converts a known mass flow equation by accounting for the influence of a discharging sprinkler spray and provide for a new fire induced mass flow calculator.

In one preferred embodiment, a method is provided for determining a compartment doorway fire and sprinkler spray water distribution induced mass flow calculator. The preferred method includes igniting a pre-mixed fire within a compartment, growing a fire to a steady state in the absence of an actuated sprinkler and flowing a fire induced mass flow through a doorway of the compartment, in which the fire induced mass flow has a neutral plane. The preferred method further includes distributing water from a sprinkler within the compartment in the presence of the steady state fire. Accordingly, the method provides for flowing a fire and sprinkler water distribution induced mass flow through the doorway, in which the fire and sprinkler water distribution induced mass flow has a neutral plane. The neutral plane of the fire and sprinkler water distribution is preferably within an operational range of the neutral plane of the fire induced mass flow. A preferred operational range provides that the neutral planes are within ten percent (10%) of one another. The preferred method includes assigning a ratio, preferably defined by a total mass flow of the fire and sprinkler water distribution induced mass flow to the total mass flow of the fire induced mass flow, to the following mass flow equation:

$${\dot{m}}_{out} = \frac{2}{3} {C}_{D} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2} .$$

In one aspect of the preferred method, assigning the ratio preferably includes determining the direction and magnitude of each of the fire induced and fire and sprinkler water distribution induced mass flows to define a mass flow profile of each of the fire induced and fire and sprinkler water distribution induced mass flows in the doorway. Assigning the ratio further preferably includes determining where along the vertical length of the doorway the mass flow switches direction so as to determine the location of the neutral plane in each of the fire induced and fire and sprinkler water distribution induced mass flow profiles.

In flowing at least one of the fire induced and fire and sprinkler water distribution induced mass flows, the flowing includes defining at least one of a pressure gradient and a temperature gradient across the doorway. Moreover, the preferred method includes determining the total mass flow of at least one of the fire induced and fire and sprinkler water distribution induced mass flow profiles. A preferred method for determining the total mass flow includes installing a grid network of spaced apart pressure probes in the doorway; obtaining a differential pressure reading from each probe; and calculating a localized mass flux for each differential pressure reading. From each calculated mass flux, the preferred method includes linearly interpolating between each of the localized mass fluxes; and summating each of the calculated and linearly interpolated mass fluxes to determine a total mass flow in the doorway and a total mass flow out of the doorway for the at least one fire induced and fire and sprinkler water distribution induced mass flow profiles.

Included in another aspect of the preferred method is determining the location of the neutral plane in at least one of the fire induced and fire and sprinkler water distribution induced mass flows. The determining preferably includes defining the height of the neutral plane relative to the floor of the compartment as it varies along the width of the doorway. More preferably, defining the height the neutral plane includes taking an average height of the neutral plane along the width of the doorway. Even more preferably, where the neutral plane of the fire and sprinkler water distribution induced mass flow is within the operational range of the neutral plane of the fire induced mass flow, the average height of the neutral plane of the fire and sprinkler water distribution induced mass flow profile is determined to be within ten percent (10%) of the average neutral plane height of the neutral plane of the fire induced mass flow profile.

In another aspect of the preferred method, igniting the pre-mixed fire includes locating the pre-mixed fire in the compartment. The compartment is preferably a test compartment having a first pair of parallel walls and a second pair of parallel walls disposed orthogonal to the first pair of walls. The second pair of walls is preferably shorter in length than the first pair of parallel walls so as to define a rectangular shaped compartment having four corners. The doorway is preferably disposed along one wall of the second pair of parallel walls and located substantially in a first corner. In the preferred method, locating the fire includes positioning the fire in a second corner opposite to and diagonal to the doorway and further preferably includes generating a substantially steady state fire size ranging from about 40 kW to about 750 kW. In the preferred method, distributing the water preferably includes locating the sprinkler in the compartment so as to be above the fire.

In another aspect of the preferred method, locating the pre-mixed fire includes locating a propane burner having a propane gas supply with a propane flow control valve, an air supply with an air flow control valve, the igniting further including setting the propane and air flow control valves such that the steady state fire size is one of: 42 kW, 75 kW and 96 kW. Preferably, igniting the pre-mixed fire is such that the size of the steady-state fire is maintained when distributing water.

Moreover, the preferred method provides that distributing the water includes discharging water from the sprinkler in the actuated state at a delivery rate of about thirteen gallons per minute (13 GPM). More preferably distributing the water includes positioning the sprinkler such that the discharging water does not directly impact the doorway. Even more preferably, locating the sprinkler includes positioning the sprinkler such that the location of the neutral plane of the fire and sprinkler water distribution induced mass flow is within the operational range of the neutral plane of the fire induced mass flow.

In an alternate embodiment, another method is provided for determining a calculator for a fire induced mass flow out of a doorway of a compartment in the presence of an actuated sprinkler. The preferred method includes forming a first mass flow profile to define a neutral plane of the first profile with the sprinkler in an unactuated state and forming a second mass flow profile to define a neutral plane of the second profile with the sprinkler in an actuated state. The preferred method further includes confirming that the neutral plane of the second profile is within an operational range with respect to the neutral plane of the first profile; determining the differential between the first mass flow profile and the second mass flow profile; and assigning the differential to the Known Mass Flow Equation.

Another embodiment provides a method of determining a sprinkler coefficient of a sprinkler. The sprinkle coefficient quantifies the ability of the sprinkler in the actuated state to reduce a fire induced mass flow through a doorway of a compartment. The alternate preferred method includes determining a first mass flow profile through the doorway over the vertical length of the doorway. The method includes determining the location of a first neutral plane of the first profile, the first mass flow profile being induced by a fire within the compartment and with the sprinkler in the unactuated state so as to define a first total mass flow out of the doorway.

The preferred method further includes determining a second mass flow profile through the doorway over the vertical length of the doorway, including determining the location of a second neutral plane. The second mass flow profile, being induced by the fire with the sprinkler in the actuated state, defines a second total mass flow out of the doorway;

The alternate preferred method includes confirming an operational range between the first and second neutral plane, determining a ratio of the second total mass flow to the first total mass flow rate; and defining the ratio as the sprinkler coefficient of the sprinkler. Determining the first mass flow profile is determined by a predictive model, such as for example, the Known Mass Flow Equation. Determining the second mass flow is preferably determined experimentally. More preferably, determining the second mass flow profile is determined by using and converting the predictive model by the ratio.

In another preferred embodiment, a method is provided for specifying the impact of an actuated sprinkler on a fire induced mass flow through a doorway of a compartment. The method preferably includes identifying a ratio of a fire induced mass flow from the compartment in the presence of the actuated sprinkler to a fire induced mass flow from the compartment in the absence of the actuated sprinkler; and assigning the ratio as a-coefficient of the sprinkler.

Identifying the ratio preferably includes igniting a pre-mixed fire within the compartment; growing the fire to a steady state in the absence of the actuated sprinkler; and flowing a first fire induced mass flow through the doorway rate so as to define a first fire induced mass rate profile having a neutral plane. The method further includes actuating the sprinkler within the compartment in the presence of the steady state fire and flowing a second fire induced mass flow through the doorway so as to define a second fire induced mass flow profile having a neutral plane within an operational range of the neutral plane of the first fire induced mass flow profile. The preferred method further includes determining the location of the neutral plane of the first fire induced mass flow profile; determining the location of the neutral plane of the second fire induced mass flow profile; determining a total mass flow of the first fire induced mass flow profile; and determining a total mass flow of the second fire induced mass flow profile.

Accordingly, the preferred systems and methods provide for a-coefficient of a sprinkler that converts a fire induced mass flow through a doorway of a compartment to a fire and sprinkler induced mass flow. In one particular embodiment of the coefficient, the-coefficient converts a theoretical fire induced mass flow through a doorway of a compartment to a fire and sprinkler water distribution induced mass flow from the doorway of the compartment.

In an alternate embodiment, a system is provided for determining a sprinkler coefficient for a sprinkler having an unactuated and an actuated state. The sprinkler coefficient preferably defines a ratio of a fire induced mass flow from a compartment having the sprinkler in the actuated state to a fire induced mass flow from the compartment with the sprinkler in the unactuated state.

The preferred system includes a test compartment having a doorway with a vertical length; a sprinkler installed within the compartment, the sprinkler including a control valve to selectively place the sprinkler in one of the actuated and unactuated states; and a burner for generating a pre-mixed fire within the test compartment in a location below the sprinkler and spaced from the sprinkler and the doorway so as to define a fire induced mass flow profile in the doorway, the profile being stratified so as to define a neutral plane along a range of the vertical length, the burner being configured to generate a fire size ranging from about 40 kW to about 750 kW. The system further preferably includes a plurality of sensors for determining at least one of a pressure and temperature differential across the doorway in the presence of the fire generated by the burner.

In the system, the preferred plurality of sensors includes a grid network of differential pressure probes. The grid network is disposed within the doorway, and the differential pressure probes are bi-directional and spaced throughout the network to determine the location of the neutral plane. Alternatively or in addition to, the plurality of sensors includes a plurality of thermocouples having a first portion to measure an upper gas temperature within the compartment; a second portion to measure a temperature proximate the differential pressure probes; and a third portion to measure an ambient temperature outside the compartment.

Further features of the preferred system preferably includes at least one of the sprinkler installed in accordance with applicable NFPA 13 standards for the compartment so as to define a maximum spacing from the burner; defining the minimum flow rate from the sprinkler when the sprinkler is in the actuated state; and having the burner include a propane burner having including a propane gas supply with a propane flow control valve and an air supply with an air flow control valve.

In yet another aspect of the preferred system, a system is provided to determine a fire induced mass flow from a doorway of a compartment with an actuated sprinkler in the compartment. The system preferably includes means for obtaining a fire induced mass flow from the doorway of the compartment without a sprinkler in the compartment; and a coefficient that converts the fire induced mass flow to a fire and sprinkler water distribution induced mass flow from the doorway of the compartment.

Preferably, the means is an experimental arrangement that includes a test compartment having a doorway with a vertical length; a burner for generating a fire within the test compartment in a location spaced from the doorway so as to define a fire induced mass flow profile in the doorway and configured to generate a fire size ranging from about 40 kW to about 750 kW; and a plurality of sensors for determining at least one of a pressure and temperature differential across the doorway in the presence of a fire generated by the burner. Alternatively, the means is at least partially theoretical and preferably provided by the Known Mass Flow Equation.

Using the preferred methods and systems described herein, a sprinkler coefficient, Cₛₚᵣᵢₙₖₗₑᵣ, has been determined. In one specific application of the methods and systems described herein, the sprinkler coefficient, Cₛₚᵣᵢₙₖₗₑᵣ has been determined for a TYCO LFII pendent residential sprinkler from TYCO FIRE SUPPRESSION & BUILDING PRODUCTS (hereinafter “TFS&BP”). The sprinkler coefficient Cₛₚᵣᵢₙₖₗₑᵣ was determined to be about 0.72 to about 0.84 and is more preferably about 0.84. The Known Mass Flow Equation is preferably multiplied by the sprinkler coefficient so as to predict a reduced fire induced mass flow out of the doorway in the presence of a sprinkler spray as compared to the induced mass flow without the sprinkler spray. Accordingly, a modified predictive model is preferably provided by:

$${\dot{m}}_{out} = \frac{2}{3} {C}_{D} {C}_{Sprinkler} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2}$$

The sprinkler coefficient Cₛₚᵣᵢₙₖₗₑᵣ acts as a conversion factor to correct the Known Mass Flow Equation in order to account for the presence of a sprinkler spray from a sprinkler. Accordingly, a system and method is provided for determining and assigning a correction factor to a sprinkler to characterize its ability to reduce fire induced mass flow.

More preferably, a preferred embodiment provides a-coefficient of a sprinkler that converts a fire induced mass flow through a doorway of a compartment to a fire and sprinkler water distribution induced mass flow from the doorway of the compartment. In an alternate embodiment, a-coefficient of a sprinkler is provided that converts a fire induced mass flow through a doorway of a compartment to a fire and sprinkler induced doorway mass flow that can be used to predict the mass flow through the doorway of a compartment in the presence of the sprinkler in its actuated state. In yet another embodiment, a sprinkler is provided having a specified-coefficient to quantify a mass flow through a doorway of a compartment in which the sprinkler is installed and in an actuated state. Thus, the preferred methods and systems provide for identification of a sprinkler-coefficient that characterizes the ability of a sprinkler to reduce a fire induced mass flow from the compartment and which can be used to provide a calculator that converts a fire induced mass flow equation to a fire and sprinkler spray discharge induced mass flow equation.

### BRIEF DESCRIPTIONS OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1. is a schematic representation of a model for fire induced mass flow.

FIG. 2 is a flow chart for a preferred method of obtaining a preferred sprinkler coefficient.

FIG. 2A-2B are graphic illustrations of mass flow profiles.

FIGS. 2C-2D is a schematic for a preferred system for use in the method of FIG. 2.

FIG. 3 is a preferred schematic assembly of the system shown in FIGS. 2A-2B.

FIG. 4A is a preferred sensor for use in the system of FIG. 3.

FIG. 4B is a sensor assembly for use in the system of FIG. 3.

FIG. 5 is a preferred embodiment of the method of FIG. 2.

FIG. 6A-6C are graphic illustrations comparing the mass flow out of doorway with and without a sprinkler spray using the method of FIG. 5.

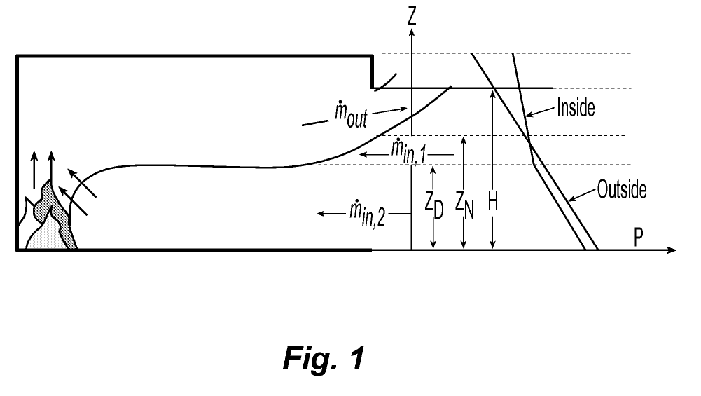

### DETAILED DESCRIPTION

A preferred calculator to determine and more preferably predict the fire induced mass flow through a vent or doorway of a compartment under the conditions of or in the presence of an actuated and discharging sprinkler is.

$${\dot{m}}_{out} = \frac{2}{3} {C}_{D} {C}_{Sprinkler} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2} ,$$

wherein \dot{m}ₒᵤₜ is the mass flow out of the doorway; C_{D} is the doorway discharge coefficient; W is the doorway width; ρ_{∞} is the ambient density; T_{∞} is the ambient temperature; T_{G} is the gas temperature; g is gravity; H is the doorway height; and Z_{N} is the neutral plane height. For the expressions described herein, appropriately corresponding metric or English units of measurements are to be used.

The preferred calculator modifies the Known Mass Flow Equation preferably by a multiplier or sprinkler coefficient, Cₛₚᵣᵢₙₖₗₑᵣ that converts the Known Mass Flow Equation for a fire induced mass flow from a compartment, in the absence of a discharging sprinkler, to an equation for a reduced fire induced mass flow from the compartment in the presence of the discharging sprinkler. More preferably, the sprinkler coefficient Cₛₚᵣᵢₙₖₗₑᵣ defines a ratio of mass flow from a compartment, in the presence of an unactuated sprinkler, to the mass flow from the compartment in the presence of the actuated sprinkler.

Accordingly, the sprinkler coefficient Cₛₚᵣᵢₙₖₗₑᵣ for a given sprinkler can be obtained by determining, preferably for a given range of fire sizes, (i) the fire induced mass flow out of a vent or doorway of a compartment in the absence of a sprinkler discharge; (ii) the reduced fire induced mass flow out of the vent or doorway in the presence of a sprinkler discharge; and the (iii) the ratio between the two mass flows. The sprinkler coefficient Cₛₚᵣᵢₙₖₗₑᵣ can be assigned to the sprinkler to characterize or quantify the ability of the sprinkler to reduce a fire induced mass flow from a compartment in the presence of a sprinkler water discharge distribution.

The preferred above calculator is further at least a function of the neutral plane height Z_{N} in the mass flow. Moreover, the calculator preferably assumes that the neutral plane of the mass flow in the presence of the actuated sprinkler discharge is in substantially the same location within the doorway as the neutral plane of the mass flow in the absence of the sprinkler discharge. More preferably, the preferred calculator assumes that the neutral plane of the mass flow in the presence of the actuated sprinkler is within an operational range of the neutral plane of the mass flow in the absence of an actuated sprinkler. The preferred operational range provides that the neutral plane of the mass flow in the presence of an actuated sprinkler discharge is located within a range of about ten percent (10%) and more preferably ranges between about 7 to 8 percent of the average height of the neutral plane of the mass flow in the absence of the sprinkler discharge. Thus, for example, where the neutral plane of the mass flow in the absence of the sprinkler discharge has an average vertical height Z_{N-AVG} within the doorway of a compartment of about 1.37 meters (m), the neutral plane of the mass flow in the presence of the sprinkler discharge preferably ranges from about 1.26 m to about 1.48 m. However it should be understood that the location between the neutral planes can further vary from one another as long as their locations can be effectively determined such that the ratio between the mass flows under the non-discharged and discharged sprinkler conditions can be ascertained.

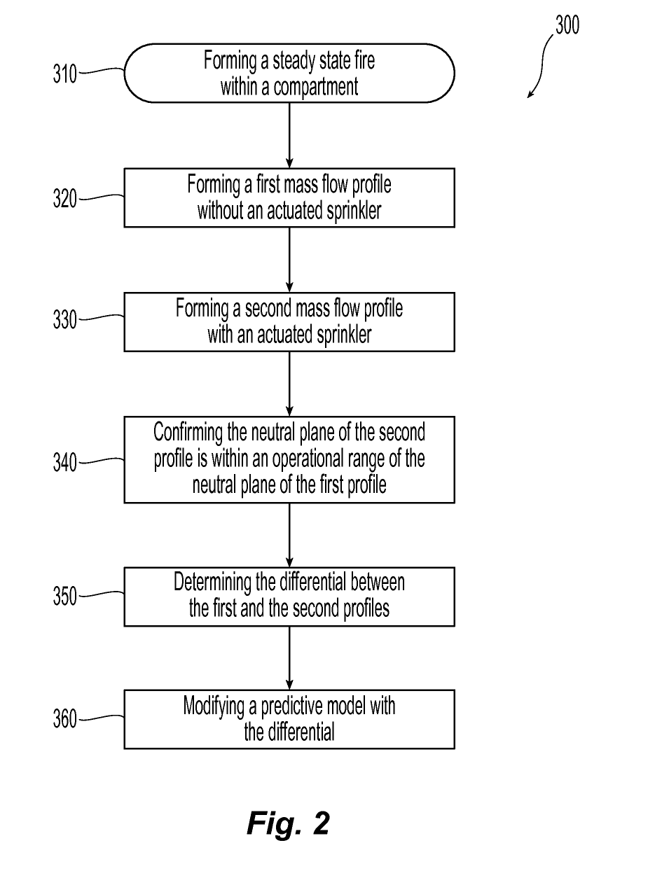

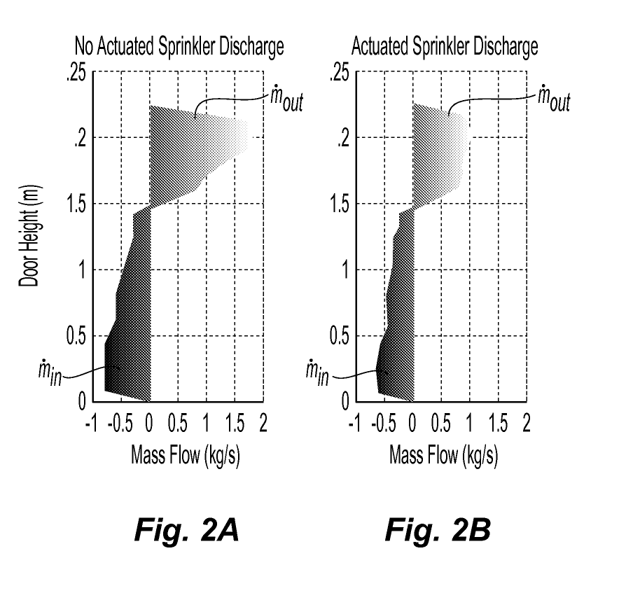

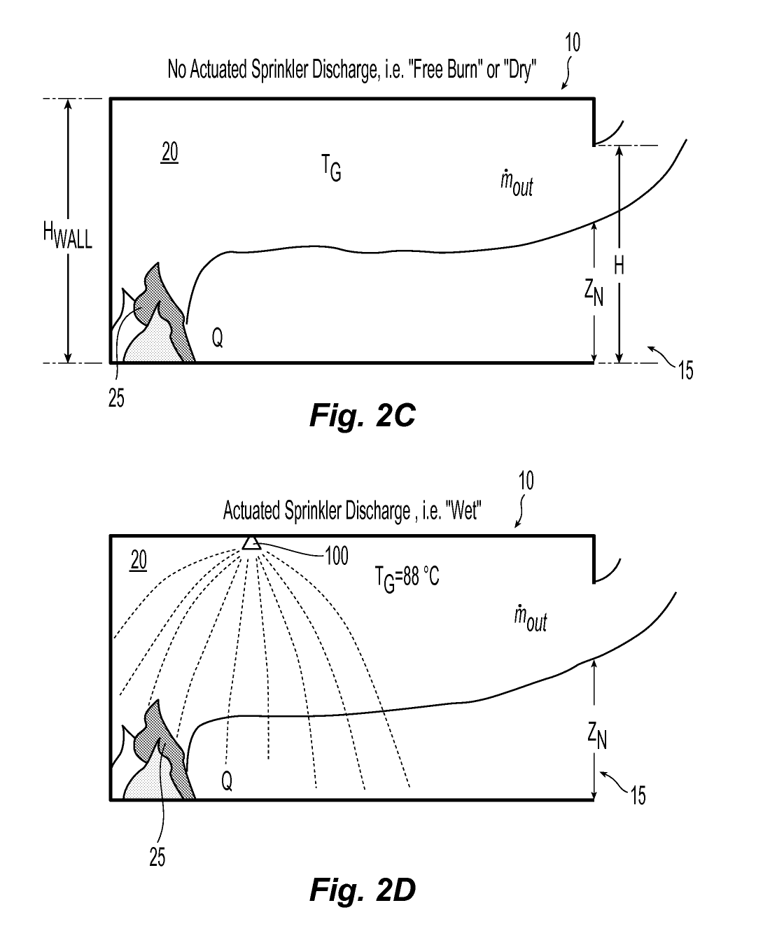

Shown in FIG. 2 is a preferred method 300 for determining the sprinkler coefficient Cₛₚᵣᵢₙₖₗₑᵣ for the preferred calculator. The preferred method 300 includes forming a steady state fire 310 within a compartment to induce a mass flow in the absence of an actuated or discharging sprinkler and form a first mass flow profile 320 in the doorway of the compartment. The fire induced mass flow further defines a neutral plane of the first profile. The preferred method further includes forming a second mass flow profile 330. The second mass flow profile is preferably formed by a mass flow out of the doorway, induced by the steady state fire, with a sprinkler in the compartment in the actuated and discharging state. The second mass flow profile preferably defines another neutral plane within the doorway of the compartment. Exemplary first and second mass flow profiles are graphically shown respectively in FIGS. 2A and 2B. Again, the neutral plane is substantially located at the transition between the mass flow out \dot{m} out and mass flow in \dot{m} in and at a height where the mass flow is approximately zero.

The preferred method 300 further includes confirming 340 that the neutral plane of the second profile is within an operational range with respect to the neutral plane of the first profile. Accordingly, the preferred method 300 for determining the sprinkler coefficient Cₛₚᵣᵢₙₖₗₑᵣ provides that the location of the neutral planes of a fire induced mass flow in the absence of a sprinkler discharge and in the presence of a sprinkler discharge is substantially the same or preferably within an operational range of one another. The preferred method 300 also includes determining the differential 350 between the first mass flow profile and the second mass flow profile, and assigning the differential 350 to a mass flow equation. The differential is preferably defined as a ratio of the first mass flow profile, in the absence of an actuated sprinkler to the second mass flow profile, in the presence of an actuated sprinkler. The ratio further preferably defines the sprinkler coefficient, Cₛₚᵣᵢₙₖₗₑᵣ with which to modify a mass flow equation such as, for example, the Known Mass Flow Equation.

In order to carry out the preferred method 300 and the other methods described herein, a preferred system is provided to determine fire induced mass flows in the absence of and in the presence of an actuated sprinkler. More specifically, the preferred system provides means for obtaining a fire induced mass flow from the doorway of the compartment with and without a discharging sprinkler in the compartment in order to determine the sprinkler coefficient Cₛₚᵣᵢₙₖₗₑᵣ. The means for obtaining a fire induced mass flow from the doorway of the compartment without an actuated sprinkler in the compartment is at least partially theoretical and can be provided by the Known Mass Flow Equation.

More preferably however, the means for obtaining a fire induced mass flow from the doorway of the compartment, with and without a discharging sprinkler, is an experimental set up that includes a test compartment having a doorway with a vertical length and a burner for generating a fire ranging in size from about 40 kW to about 750 kW within the test compartment at a location spaced from the doorway. The fire induces a mass flow so as to define a fire induced mass flow profile in the doorway. The test compartment further preferably includes sensors for determining at least one of a pressure and temperature differential across the doorway in the presence of the fire.

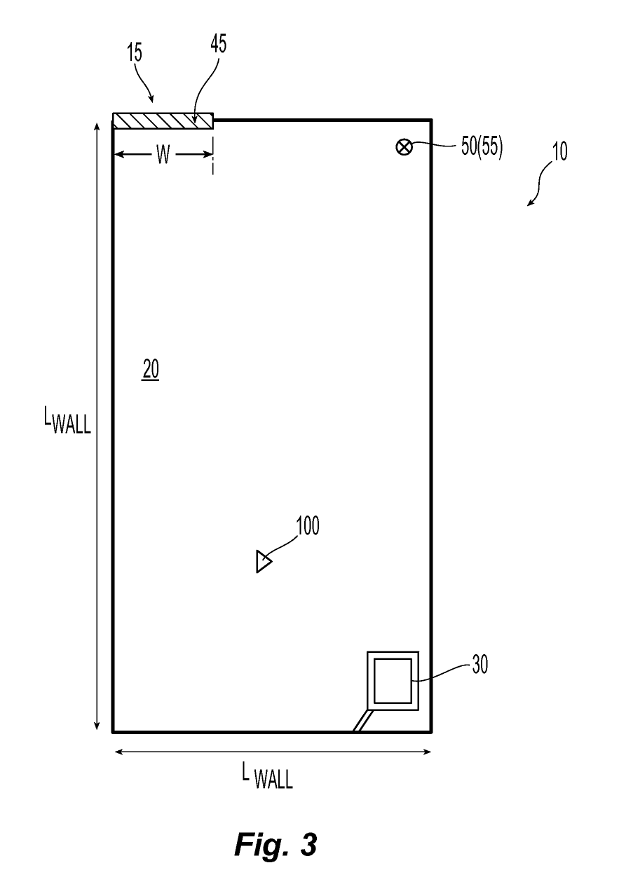

Shown schematically in FIGS. 2C and 2D is a preferred system 10. Generally, the preferred system 10 is constructed to evaluate the mass flow \dot{m} from a doorway 15 of a compartment 20 for a given fire size initially in the absence of an actuated sprinkler, i.e, a “free burn,” situation as shown in FIG. 2C, and subsequently in the presence of an actuated and discharging sprinkler, as shown in FIG. 2D. The compartment 20 of the system 10, as shown in FIG. 3, is preferably constructed as a rectangle having a first pair of walls 12 with a dimension (length L_{wall}×height H_{wall}) of 32 feet (fts) (9.75 m.)×8 ft. (2.44 m.) and a second pair of walls 14 with a dimensions of 16 ft. (4.88 m.)×8 ft. (2.44 m.). The test compartment is preferably sized to the test room size requirements under industry accepted standards for fire testing such as, for example, Underwriters Laboratories Inc. (UL) standard entitled, “UL 1626: Residential Sprinklers for Fire Protection Service” (Mar. 14, 2008). The vent or doorway 15 preferably defines an opening having dimensions (width W and height H) of 41 inches (in.) (1.4 m.)×88 in. (2.24 m.) The doorway 15 is preferably located along one of the second pairs of walls 14 and more preferably located in the corner. The doorway is further preferably located within the compartment 20 so as to define a discharge coefficient C_{D} in the Known Mass Flow Equation preferably of about 0.76 although the discharge coefficient C_{D} can range from about 0.68 to about 0.73. The compartment 20 is preferably lined with plywood walls and has a gypsum board ceiling and a cement floor. All cracks and openings in the room other than the doorway were sealed to prevent unwanted mass losses.

To induce the mass flow and locate the fire 25 within the compartment 20, a burner 30 is located in the compartment 20 preferably in one corner of the compartment 20. More preferably the burner 30 is square (18 in.×18 in.) constructed from copper piping located in a corner opposite and diagonally to the doorway 15. The burner 30 is configured to generate fires ranging in size from approximately of 40 kW-750 kW, and is preferably fire sizes of about 42-43 kW, 75 kW, and 96 kW (±5 kW). The burner is further preferably configured to generate a pre-mixed fire having a propane burner that included a propane gas supply with a propane flow control valve, an air supply with an air flow control valve and corresponding flow meters and gas pressure regulators. The gas fuel is preferably split in half directly before the burner to prevent flame blow off. To control the test fire size, the premixed fuel and air levels were measured preferably using two Series Omega FL-2000-FL2069 flow meters from OMEGA ENGINEERING, INC. Although the preferred meters were designed for air, they were calibrated for use with a clean gas flow, such as propane, by reading 80% of the value indicated by the meter. Heat release rates were determined indirectly by converting fuel volumetric flow rate to mass flow rates from which the heat release rate was calculated. The table below provides a summary of the fuel and air flow rates that provide the stated tested fire sizes.

FUEL:AIR - FIRE SIZE TABLE

| FUEL FLOW | AIR | FIRE SIZE |
|---|---|---|
| (CFM) | (CFM) | (Heat Release Rate (kW)) |
| 1 | 8.5 | ≈40 |
| 1.8 | 15 | ≈75 |
| 2.25 | 20 | ≈100 |

In the system 10 and preferably above the burner 30 the sprinkler 100 is installed. The sprinkler 100 is preferably a pendent residential sprinkler, such as for example, the residential sprinkler Series LFII (TY2234) Residential Pendent Sprinkler from TFS&BP shown in the data sheet attached as Appendix E of Exhibit A of U.S. Patent Provisional Application No. 61/064,698 which is incorporated by reference in its entirety. Other sprinklers can be installed for determination of the sprinkler coefficient Cₛₚᵣᵢₙₖₗₑᵣ. For example, another sprinkler for installation is the standard spray sprinkler Series TY-B (TY3251) 5.6 K-Factor Pendent Sprinkler also from TFS&BP shown and described in TFS&BP Data Sheet TFP151 entitled, “Series TY-B-2.8, 5.6, and 8.0 K-factor Upright, Pendent, and Recessed Pendent Sprinklers Standards Response, Standard Coverage” (December 2007) which is incorporated by reference in its entirety.

The sprinkler is preferably installed within the compartment in accordance with one or more industry accepted standards such as for example, (i) National Fire Protection Association (NFPA) standard entitled “NFPA 13: Standard for the Installation of Sprinkler Systems” (2007 ed.); (ii) “NFPA 13R: Standard for the Installation of Sprinkler Systems in Residential Occupancies up to and Including Four Stories in Height” (2007 ed.); and/or (iii) “NFPA 13D: Standard for the Installation of Sprinkler Systems in One- and Two-Family Dwellings and Manufactured Homes” (2007 ed.). Accordingly, the sprinkler spacing within the compartment from the compartment walls, doorway and fire are preferably defined by the applicable installation standard requirements. The installation standards further preferably define the water flow minimum water flow requirements for the sprinkler 100. Thus where, for example, the sprinkler 100 is the Series LFII Residential Sprinkler installed in accordance with NFPA 13, the minimum flow rate from the sprinkler is thirteen gallons per minute (13 GPM). The water flow from the sprinkler 100 is preferably manually controlled by a valve piped in connection with the sprinkler 100. Accordingly, the automatic thermally responsive actuation device of the sprinkler 100 is removed prior to installation of the sprinkler 100 within the compartment 20.

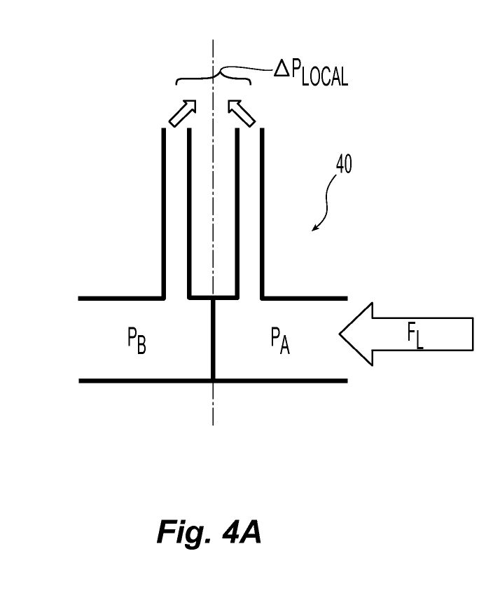

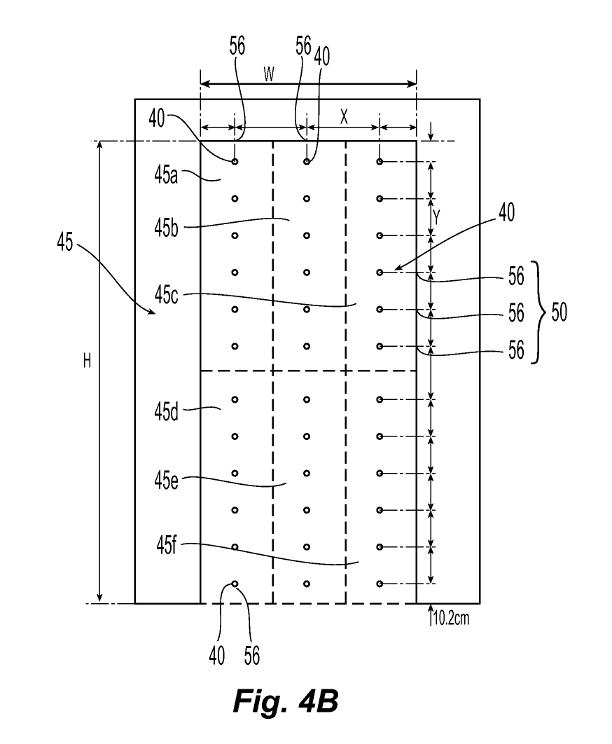

Fire induced mass flow through the doorway 15 of the compartment 20, in the presence of or out of the presence of an actuated discharging sprinkler 100, is preferably experimentally determined by a function relating measured values of gas temperature and differential pressure. In particular, the preferred system 10 includes an first plurality or an array assembly 45 of sensors to measure the difference in pressure across the doorway 15 due to gas leaving the doorway. The assembly 45 is made from a network tree of differential pressure probes 40 such as that schematically shown in FIG. 4A. The preferred pressure probe assembly 45 is shown in FIG. 4B.

The assembly 45 is preferably located in the doorway 15, as seen in FIG. 3, to locate the grid network of probes 40 in the doorway for determining a pressure differential in a specific location of the doorway 15 defined by a vertical height and horizontal distance from the door frame. Because the pressure probes 40 are differential pressure probes, the probes can determine the location in the doorway where the pressure changes from positive pressure to a negative pressure. More specifically, the probe assembly is configured to determine the location, both vertically and along the width of the doorway, of a transition or change in flow direction from out the doorway 15 to in the doorway 15.

Referring again to the schematic of FIG. 4A, the probe 40 is installed so as to measure the pressure on either side of the vertical plane defined by the doorway 15. The direction of flow F_{L} is determined by the direction of decreasing pressure across the vertical plane of the doorway 15. In FIG. 4A, the flow is illustrated in the direction from greater stagnation pressure P_{A} to the downstream side having slightly less than static pressure P_{B}. Accordingly, the probe assembly can locate the vertical height of the transition zone or neutral plane Z_{N} in which the flow is in zero state by identifying the point of change in direction of flow F_{L}.

The system 10 includes a second plurality of sensors 50 for measuring the average upper gas temperature of the compartment 20, the temperature at each probe or bi-directional sensors 40 and the ambient temperature outside the compartment 20. More preferably, the upper gas temperature T_{G} is determined using a thermocouple tree formed by thirteen Type K-24 gauge thermocouples 55 placed in a corner of the compartment 20 (spaced 0.3 m from any wall). The beads are preferable spaced vertically about 0.15 m. apart from one another starting 0.15 m below the ceiling and ending 0.3 m above the floor. The upper gas layer temperature is obtained by determining the location of the smoke layer interface Z_{D} and averaging the temperatures above the interface. To identify the smoke layer interface, an average was taken of two heights over which there was the greatest reduction in temperature.

In addition to the five thermocouples, the second plurality of sensors 50 preferably includes, for each pressure probe 40, a single thermocouple 56 located next to the pressure probe 40 in the assembly 45. Referring back to FIG. 4B, six sensors 40, 56 are preferably vertically spaced Y by about 18 centimeters (cm) to define an array covering one sixth (⅙) of the doorway. The array is repositionable in the vertical and horizontal direction to cover the doorway area (height H and width W) by six testing regions 45a, 45b, 45c, 45d, 45e, and 45f in which the sensors take localized temperature T_{local} and differential pressure ΔP_{local} readings in a region of the doorway 15 for a given set of test conditions. In the preferred assembly 45, the movable array of sensors 40, 50 horizontally spaces the sensor X about 35 cm. apart. Accordingly over the doorway area, a total of thirty-six sensor readings are taken for a given set of test conditions.

The localized sensor readings T_{local}, ΔP_{local} are used to determine the localized mass flux (mass flow per unit area) in the doorway proximate the sensor. To determine the localized mass flux as a function of localized temperature and differential pressure, the following formula was used.

$${\dot{m}}^{″} = \frac{26.57}{{C}_{f } {T}_{local}} \sqrt{{T}_{local} {P}_{local}}$$

The mass flux equation was derived such that it is also a function of a calibration factor C_{ƒ0} of the pressure probes. The calibration factor C_{ƒ} for the differential pressure probe calibrates its measurements to account for the loss of any actual pressure through the sensor. The calibration factor was determined through plunge tunnel testing in which the probes 40 were calibrated against a known pressure. It was determined that the calibration factor C_{ƒ} for the probes is about 1.07. Further explanation of the calibration factor and the derivation of the localized mass flux equation are detailed in the Exhibits to U.S. Provisional Application No. 61/064,698 (pages 55-58) and Provisional Application No. 61/129,030 each of which is incorporated by reference in their entireties.

The total mass flow out of the doorway is determined by interpolation between the localized data points for the calculated max fluxes. Accordingly, the total mass is determined by summation using the formula below. Preferably, the interpolation is over 100 points between each localized data reading (n=100) and A is the area of the doorway which remains constant.

$$\dot{m} = {\sum }_{k = 1}^{n} {A}_{i} {\dot{m}}_{k}^{″}$$

The mass flows calculated using the collected temperature and pressure data in combination with interpolation technique described can be used to define the magnitude and direction of the mass flow through the doorway 15 of the compartment 20. Moreover, the resulting mass flows can be graphically plotted to define a mass flow profile as seen for example, in FIGS. 2A and 2B. Although the plots show the variation of the mass flow profile over the vertical length of the door, the plots can be configured to define the variations in magnitude and direction of the mass flow profile over the width of the door.

To determine the ambient temperature T_{∞}, a thermocouple-was located in three locations. The first two locations are on the bottom of the pressure probe assembly 45 to evaluate the temperature of incoming fresh ambient air and the temperature profile in the doorway. A third thermocouple-was used to monitor the ambient air away from the doorway. This thermocouple-was located outside the compartment out of direct view of the doorway 15 and was placed three feet above the floor. The average of all three thermocouples was used for the ambient air temperature throughout analysis.

More preferably, the ambient temperature can be determined by locating a thermocouple tree-outside of the compartment. The preferred tree includes four thermocouples 0.6 meters apart beginning 0.5 m. above the floor. In order to obtain the ambient temperature T_{∞} the average of the temperature readings from the thermocouple tree-is preferably used.

The preferred system 10 can be used to carry out the preferred method 300. In particular, the system 10 can be used to initiate and grow a steady state fire 25 and flow a fire induced mass flow through a doorway 15 of the compartment 20 in the absence of any discharge from the sprinkler 100. The first and second plurality of sensors 45, 50 can be employed to determine the location of the neutral plane of the fire induced mass flow within the doorway 15. With the fire 25 in its steady state, water can be distributed from the sprinkler 100 and change in the mass flow through the doorway 15 of the compartment 20 can be monitored using the plurality of sensors 45, 50. Preferably, the size of the steady state fire 25 is maintained, and more preferably, the data from the sensors 45, 50 confirms that the neutral plane of the fire induced mass flow, in the presence of the discharging sprinkler 100, is located within an operational range of the neutral plane of the fire induced mass flow without any sprinkler discharge.

Pressure and temperature data from the sensors are used to determine, graphically or quantitatively, the fire induced mass flow through the doorway 15 of the compartment 20 for the test scenario with the sprinkler 100 in the unactuated non-discharging condition (i.e., the “dry” condition) and another test scenario with the sprinkler 100 in the actuated discharging condition (i.e., the “wet” condition). Preferably, the data is used to determine both the fire induced mass flow in and the fire induced mass flow out of the doorway 15. Moreover, the pressure and temperature data is used to determine mass flow profiles for each of the test scenarios collected, preferably including the magnitude and direction each of the mass flow profile. Accordingly, the total fire induced mass flow out of the doorway 15 can be determined for each “dry” and “wet” test scenario and their differential calculated. Preferably, the differential between two test scenarios is expressed as a ratio of their respective total fire induced mass flow rates out of the doorway 15. The ratio preferably defines the sprinkler coefficient Cₛₚᵣᵢₙₖₗₑᵣ for modification of the Known Mass Flow Equation to define the preferred calculator.

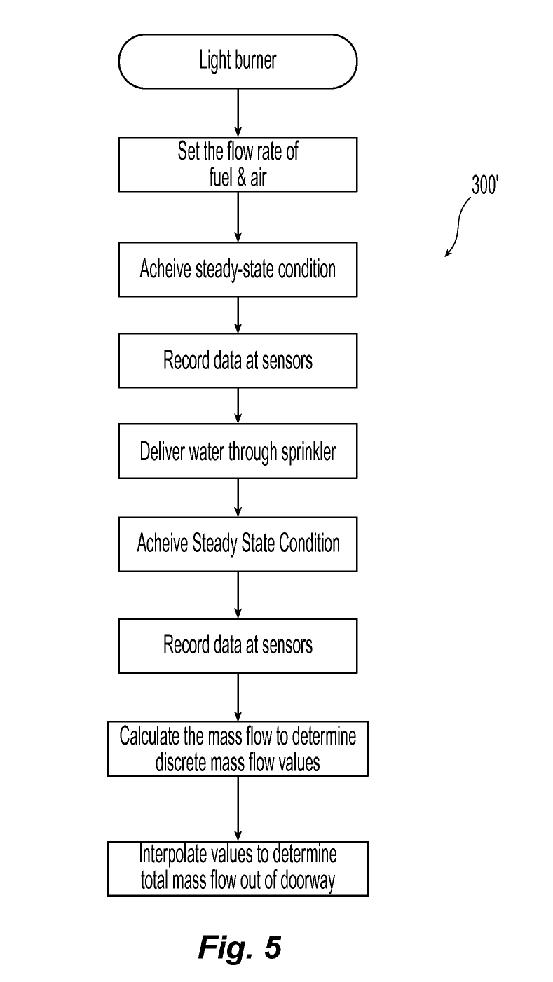

A series of fire tests was conducted using the preferred system 10 over a range of fire sizes to determine the sprinkler coefficient Cₛₚᵣᵢₙₖₗₑᵣ of two sprinklers: i) Series LFII (TY2234) Residential Pendent Sprinkler; and ii) the Series TY-B (TY3251) 5.6 K-Factor Pendent Sprinkler. The preferred test method, an embodiment of the preferred method 300, for determining the sprinkler coefficient Cₛₚᵣᵢₙₖₗₑᵣ, is outlined generally as method 300′ in FIG. 5. More specifically, the test procedure includes the followings steps:

### Test Procedure Steps

1) Igniting the burner to generate the pre-mix fire
2) Set propane flow rate
3) Set air flow rate
4) Condition room for at least 30 minutes or until the compartment achieves a steady state
5) Record data from probes (“Dry” Test Data)
6) Turn on sprinkler
7) Maintain steady-state fire condition
8) Record data from probes (“Wet” Test Data)

Temperature and pressure data gathered from the sensors—for each sprinkler—is respectively tabulated in the results tables below and analyzed to determine the effects of sprinkler spray on fire induced doorway flows. For each fire size Q(kW) the temperature and differential pressure data was collected, the neutral zone height determined and the total mass flow out calculated. More specifically, the collected data was used in combination with the interpolation techniques described above to determine the mass flow magnitude and direction over the vertical length of the doorway to define the mass flow profiles for each test scenario.

Series LFII (TY2234) Residential Sprinkler - Results Table

| | Q | | T_{g} | T_{∞} | N | Mₒᵤₜ | |
|---|---|---|---|---|---|---|---|
| Test # | (kW) | Water | (K) | (K) | (m) | (kg/s) | Cₛ |
| 1D | 42 | On | 326 | 301 | 1.43 | 0.52 | 0.80 |
| 1W | 42 | Off | 309 | 300 | 1.34 | 0.42 | |
| 2D | 42 | On | 327 | 299 | 1.44 | 0.55 | 0.74 |
| 2W | 42 | Off | 309 | 300 | 1.33 | 0.41 | |
| 3D | 42 | On | 323 | 299 | 1.37 | 0.51 | 0.82 |
| 3W | 42 | Off | 308 | 299 | 1.31 | 0.42 | |
| 4D | 42 | On | 335 | 295 | 1.45 | 0.58 | 0.72 |
| 4W | 42 | Off | 312 | 294 | 1.43 | 0.42 | |
| 5D | 75 | On | 352 | 299 | 1.36 | 0.72 | 0.81 |
| 5W | 75 | Off | 331 | 301 | 1.41 | 0.58 | |
| 6D | 75 | On | 355 | 300 | 1.38 | 0.71 | 0.84 |
| 6W | 75 | Off | 333 | 301 | 1.37 | 0.60 | |
| 7D | 75 | On | 355 | 301 | 1.42 | 0.69 | 0.78 |
| 7W | 75 | Off | 325 | 302 | 1.34 | 0.54 | |
| 8D | 75 | On | 364 | 301 | 1.45 | 0.68 | 0.82 |
| 8W | 75 | Off | 332 | 297 | 1.46 | 0.55 | |
| 9D | 96 | On | 408 | 305 | 1.40 | 0.88 | 0.69 |
| 9W | 96 | Off | 354 | 308 | 1.43 | 0.61 | |
| 10D | 96 | On | 389 | 306 | 1.43 | 0.80 | 0.77 |
| 10W | 96 | Off | 357 | 307 | 1.46 | 0.62 | |
| 11D | 96 | On | 385 | 305 | 1.39 | 0.79 | 0.81 |
| 11W | 96 | Off | 348 | 306 | 1.36 | 0.64 | |
| 12D | 96 | On | 376 | 301 | 1.45 | 0.72 | 0.82 |
| 12W | 96 | Off | 338 | 297 | 1.46 | 0.59 | |
| | | | | | | Average Cₛ | 0.78 |
| | | | | | | Max Cₛ | 0.84 |

According to the test results for the Series LFII (TY2234) Residential Sprinkler, the two-zone model was preserved and the neutral plane, in the presence of the discharging sprinkler spray, was located within an operational range of the neutral plane in the absence of the sprinkler spray. Accordingly, the results of the fire tests are useful in determining the fire induced mass flows and the sprinkler coefficient Cₛₚᵣᵢₙₖₗₑᵣ.

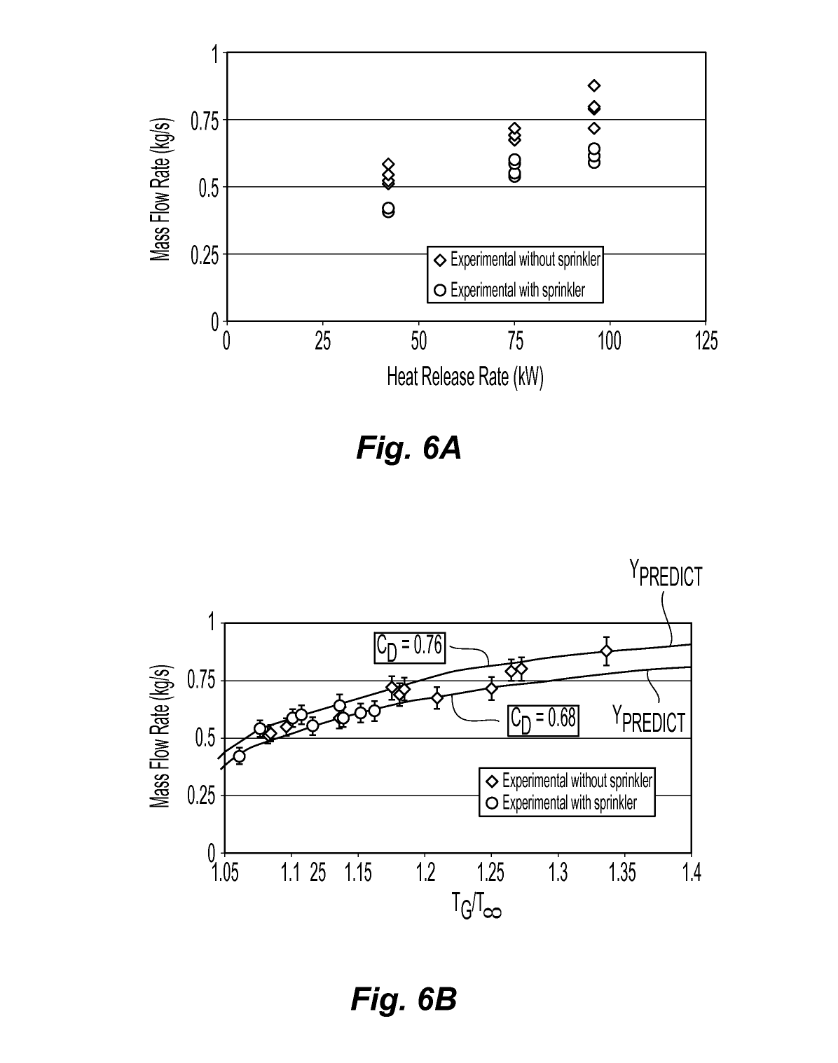

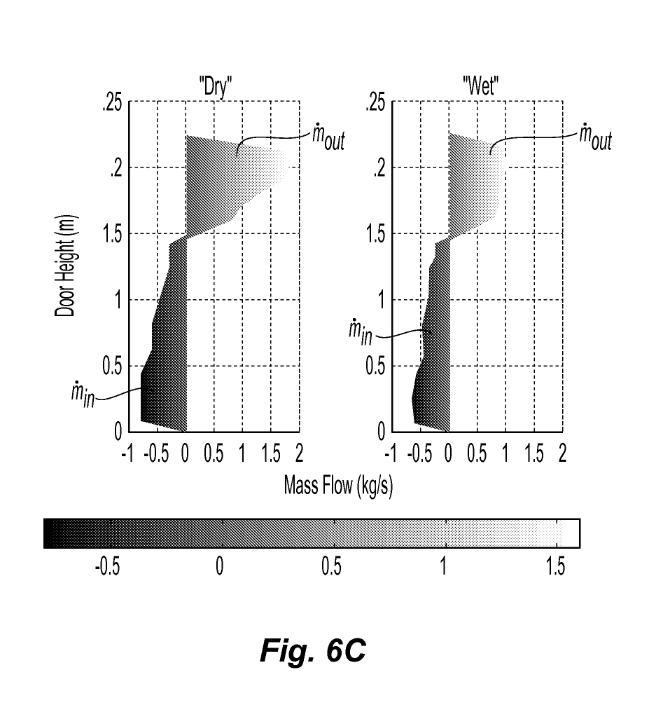

For the various fire sizes, the mass flow out of the doorway was reduced in the presence of the spray of the Residential Sprinkler as compared to the mass flow in the absence of the sprinkler spray. The “wet” fire tests demonstrated the effect in which the upper gas layer resulted in a reduction in the fire induced mass flow out of the doorway 15 of the compartment 20. For each of the “dry” and “wet” test scenarios, the fire mass flow Mₒᵤₜ (kg/s) was determined from the experimentally collected localized temperature T_{local} and differential pressure, ΔP_{local} using the summation and interpolation techniques described above. The reduction in mass flow from the “dry” test scenario to the “wet” test scenario is graphically shown in FIGS. 6A-6C. From the preferred system and methods, the inventor has discovered that for the sprinkler 100, the fire induced doorway mass flow was reduced by approximately 20% and more particularly about 16% regardless of the fire size. For the Series LFII (TY2234) Residential Sprinkler, the sprinkler-coefficient Cₛₚᵣᵢₙₖₗₑᵣ ranges from about 0.72 to about 0.84 with an average of about 0.78 which to modify the Known Mass Flow Equation and provide for the preferred calculator to predict the impact, and more define the reduction in fire induced mass flow due to discharge from the sprinkler. The sprinkler-coefficient Cₛₚᵣᵢₙₖₗₑᵣ is more preferably about 0.84 for the Series LFII (TY2234) as it demonstrates the most conservative-coefficient for the subject sprinkler by minimally quantifying the mass flow effect of the sprinkler discharge in reducing a fire induced mass flow.

For comparison purposes, shown in FIG. 6B are the experimentally determined mass flows about the calculated curves using the preferred calculator for the given test configuration. Two calculated curves Y_{Predict} were determined by plugging into the preferred calculator, the temperature readings of the upper gas temperature T_{G}, ambient temperature in combination with the determined sprinkler coefficient Cₛₚᵣᵢₙₖₗₑᵣ and neutral zone height. Two different discharge coefficients C_{D} were used in the curves Y_{predict} to illustrate the preferred range of discharge coefficient C_{D} of about 0.68 to 0.76. The close fit between the experimental results and the curves Y_{Predict} shows that the calculator can be a predictor of mass flow under sprinkler discharge conditions. Moreover, the sprinkler coefficient Cₛₚᵣᵢₙₖₗₑᵣ can serve to characterize or quantify the mass flow effect of a sprinkler.

Similar fire tests were conducted using the standard spray Series TY-B (TY3251) 5.6 K-Factor Pendent Sprinkler as the sprinkler 100 in the system 10. The standard spray sprinkler was installed in accordance with NFPA 13 and it was determined that the flow rate for the sprinkler in the system 10 would be about 14.8 GPM. The sensor assembly 45 in the system 10 was slightly modified by having eleven sensors 40, 56 vertically spaced to cover ⅓ of the doorway area. The array is repositionable to cover the entire doorway area. Accordingly a total of thirty-three data sensor readings are taken for a given set of test conditions. Shown below is the results table from the fire tests for the Series TY-B (TY3251) Pendent Sprinkler.

Series TY-B (TY3251) 5.6 K-Factor
Pendent Sprinkler - Results Table

| | Q | | T_{g} | T_{∞} | N | Mₒᵤₜ | |
|---|---|---|---|---|---|---|---|
| Test # | (kW) | Water | (K) | (K) | (m) | (kg/s) | Cₛ |
| 6D | 100 | Off | 376 | 295 | 1.27 | 0.80 | 0.84 |
| 6W | 100 | On | 343 | 294 | 1.26 | 0.67 | |
| 7D | 50 | Off | 335 | 291 | 1.43 | 0.59 | 0.92 |
| 7W | 50 | On | 311 | 291 | 1.32 | 0.54 | |
| 8D | 50 | Off | 338 | 292 | 1.35 | 0.63 | 0.89 |
| 8W | 50 | On | 314 | 291 | 1.31 | 0.56 | |
| 11D | 100 | Off | 379 | 291 | 1.44 | 0.75 | 0.85 |
| 11W | 100 | On | 344 | 292 | 1.36 | 0.64 | |
| 12D | 50 | Off | 338 | 292 | 1.37 | 0.67 | 0.79 |
| 12W | 50 | On | 315 | 291 | 1.35 | 0.53 | |
| 13D | 75 | Off | 348 | 292 | 1.42 | 0.65 | 0.94 |
| 13W | 75 | On | 325 | 292 | 1.39 | 0.61 | |
| 14D | 75 | Off | 350 | 293 | 1.38 | 0.68 | 0.93 |
| 14W | 75 | On | 325 | 293 | 1.38 | 0.63 | |
| 15D | 75 | Off | 350 | 294 | 1.44 | 0.61 | 0.93 |
| 15W | 75 | On | 323 | 294 | 1.36 | 0.57 | |
| 16D | 100 | Off | 385 | 295 | 1.41 | 0.77 | 0.94 |
| 16W | 100 | On | 355 | 295 | 1.40 | 0.72 | |
| | | | | | | Average Cₛ | 0.89 |
| | | | | | | Maximum Cₛ | 0.94 |

From the experimental results, it was determined that a fire induced mass flow was reduced in the presence of the sprinkler discharge from the actuated Series TY-B (TY3251) Pendent Sprinkler. After determining the mass flow and rate for each of the dry and wet scenarios, a range of sprinkler coefficients Cₛₚᵣᵢₙₖₗₑᵣ were determined for a range of fires. For the Series TY-B (TY3251) Pendent Sprinkler the sprinkler-coefficient Cₛₚᵣᵢₙₖₗₑᵣ ranged from about 0.79 to about 0.94 with an average of about 0.89 with which to modify the Known Mass Flow Equation and provide for the preferred calculator to predict the impact, and more preferably define the reduction in fire induced mass flow due discharge from the sprinkler. The sprinkler coefficient Cₛₚᵣᵢₙₖₗₑᵣ for the Series TY-B (TY3251) Pendent Sprinkler is preferably about 0.94 as it demonstrates the most conservative-coefficient for the subject sprinkler by minimally quantifying the mass flow effect of the sprinkler discharge in reducing a fire induced mass flow.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A method of determining a compartment doorway fire and sprinkler spray water distribution induced mass flow calculator, the method comprising:
igniting a pre-mixed fire within the compartment;
growing the fire to a steady state in the absence of an actuated sprinkler;
flowing a fire induced mass flow through the doorway, the fire induced mass flow having a neutral plane;
distributing water from a sprinkler within the compartment in the presence of the steady state fire;
flowing a fire and sprinkler water distribution induced mass flow through the doorway, the fire and sprinkler water distribution induced mass flow having a neutral plane within an operational range of the neutral plane of the fire induced mass flow; and
assigning a ratio of a total mass flow of the fire and sprinkler water distribution induced mass flow to a total mass flow of the fire induced mass flow to the following mass flow equation
$${\dot{m}}_{out} = \frac{2}{3} {C}_{D} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2} ,$$
wherein
\dot{m}ₒᵤₜ is the mass flow out of the doorway;
C_{D} is the doorway discharge coefficient;
W is the doorway width;
ρ_{∞} is the ambient density;
T_{∞} is the ambient temperature;
T_{G} is the gas temperature;
g is gravity;
H is the doorway height; and
Z_{N} is the neutral plane height.

2. The method of claim 1, wherein assigning the ratio includes determining the direction and magnitude of each of the fire induced and fire and sprinkler water distribution induced mass flows to define a mass flow profiles of each of the fire induced and fire and sprinkler water distribution induced mass flows in the doorway.

3. The method of claim 2, wherein assigning the ratio includes determining where along the vertical length of the doorway the mass flow switches direction so as to determine the location of the neutral plane in each of the fire induced and fire and sprinkler water distribution induced mass flow profiles.

4. The method of claim 1, wherein flowing at least one of the fire induced and fire and sprinkler water distribution induced mass flows includes defining at least one of a pressure gradient and a temperature gradient across the doorway.

5. The method of claim 1, further including determining the total mass flow of at least one of the fire induced and fire and sprinkler water distribution induced mass flow profiles, the determining of the total mass flow includes:
installing a grid network of spaced apart pressure probes in the doorway;
obtaining a differential pressure reading from each probe;
calculating a localized mass flux for each differential pressure reading;
linearly interpolating between each of the localized mass fluxes; and
summating each of the calculated and linearly interpolated mass fluxes to determine a total mass flow in the doorway and a total mass flow out of the doorway for the at least one fire induced and fire and sprinkler water distribution induced mass flow profiles.

6. The method of claim 1, further comprising determining the location of the neutral plane in at least one of the fire induced and fire and sprinkler water distribution induced mass flows, the determining including defining the height of the neutral plane relative to the floor of the compartment as it varies along the width of the doorway.

7. The method of claim 6, wherein defining the height the neutral plane includes taking an average height of the neutral plane along the width of the doorway.

8. The method of claim 7, wherein flowing the fire and sprinkler water distribution induced mass flow such that the neutral plane of the fire and sprinkler water distribution induced mass flow is within the operational range of the neutral plane of the fire induced mass flow includes determining that the average neutral plane height of the neutral plane of the fire and sprinkler water distribution induced mass flow profile is within about ten percent of the average neutral plane height of the neutral plane of the fire induced mass flow profile.

9. The method of claim 1, wherein igniting the pre-mixed fire includes:
locating the pre-mixed fire in the compartment, the compartment being a test compartment, the test compartment having a first pair of parallel walls and a second pair of parallel walls disposed orthogonal to the first pair of walls, the second pair of walls being shorter in length than the first pair of parallel walls so as to define a rectangular shaped compartment having four corners, the doorway being disposed along one wall of the second pair of parallel walls and located substantially in a first corner; the locating the fire including positioning the fire in a second corner opposite to and diagonal to the doorway, the locating the fire including generating a substantially steady state fire size ranging from about 40 kW to about 750 kW; and
wherein further, distributing the water includes locating the sprinkler in the compartment so as to be above the fire.

10. The method of claim 9, wherein locating the pre-mixed fire includes locating a propane burner having a propane gas supply with a propane flow control valve, an air supply with an air flow control valve, the igniting further including setting the propane and air flow control valves such that the steady state fire size is one of: 42 kW, 75 kW and 96 kW.

11. The method of claim 10, wherein distributing the water includes discharging water from the sprinkler in the actuated state at a delivery rate of about thirteen gallons per minute (13 GPM).

12. The method of claim 9, wherein locating the sprinkler includes positioning the sprinkler such that the discharging water does not directly impact the doorway.

13. The method of claim 12, wherein locating the sprinkler includes positioning the sprinkler so as to define the location of the neutral plane of the fire and sprinkler water distribution mass flow within the operational range.

14. The method of claim 1, wherein igniting the pre-mixed fire is such that the size of the steady-state fire is maintained when distributing water.

15. A method of determining a calculator for fire induced mass flow out of a doorway of a compartment in the presence of an actuated sprinkler, the method comprising:
forming a first mass flow profile to define a neutral plane of the first profile with the sprinkler in an unactuated state;
forming a second mass flow profile to define a neutral plane of the second profile with the sprinkler in an actuated state;
confirming that the neutral plane of the second profile is within an operational range with respect to the neutral plane of the first profile; and
determining the differential between the first mass flow profile and the second mass flow profile; and
assigning the differential to the following mass flow equation
$${\dot{m}}_{out} = \frac{2}{3} {C}_{D} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2} ,$$
wherein
\dot{m}ₒᵤₜ is the mass flow out of the doorway;
CD is the doorway discharge coefficient;
W is the doorway width;
ρ_{∞} is the ambient density;
T_{∞} is the ambient temperature;
T_{G} is the gas temperature;
g is gravity;
H is the doorway height; and
Z_{N} is the neutral plane height.

16. The method of claim 15, wherein forming at least one of the first and second mass flow profiles includes defining the direction and magnitude of the mass flow over the vertical length of the doorway.

17. The method of claim 16, wherein defining the direction and magnitude includes determining where along the vertical length of the door the mass flow switches direction.

18. The method of claim 15, wherein forming at least one of the first and second mass flow profiles includes defining at least one of a pressure gradient and a temperature gradient across the doorway.

19. A method of determining a sprinkler coefficient of a sprinkler having an actuated state and an unactuated state, the sprinkler coefficient quantifying the ability of the sprinkler in the actuated state to reduce a fire induced mass flow through a doorway of a compartment, the method comprising:
determining a first mass flow profile through the doorway over the vertical length of the doorway, the determining including determining the location of a first neutral plane of the first profile, the first mass flow profile being induced by a fire within the compartment and with the sprinkler in the unactuated state so as to define a first total mass flow out of the doorway;
determining a second mass flow profile through the doorway over the vertical length of the doorway, the determining including determining the location of a second neutral plane, the second mass flow profile being induced by the fire with the sprinkler in the actuated state so as to define a second total mass flow out of the doorway;
confirming an operational range between the first and second neutral plane;
determining a ratio of the second total mass flow to the first total mass flow rate; and
defining the ratio as the sprinkler coefficient of the sprinkler.

20. The method of claim 19, wherein at least one of determining the first mass flow and determining the second mass flow is determined experimentally.

21. The method of claim 19, wherein determining the first mass flow profile is determined by a predictive model, the model being:
$${\dot{m}}_{out} = \frac{2}{3} {C}_{D} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2} ,$$
wherein
\dot{m}ₒᵤₜ is the mass flow out of the doorway;
CD is the doorway discharge coefficient;
W is the doorway width;
ρ_{∞} is the ambient density;
T_{∞} is the ambient temperature;
T_{G} is the gas temperature;
g is gravity;
H is the doorway height; and
Z_{N} is the neutral plane height.

22. The method of claim 21, wherein determining the second mass flow profile is determined by using and converting the predictive model by the ratio.

23. The method of claim 19, wherein determining at least one of the first and second mass flow profiles includes:
locating the fire in the compartment, the compartment having a first and second pair of parallel walls disposed orthogonal to the first pair of walls, the second pair of walls being shorter in length than the first pair of parallel walls so as to define a rectangular shaped compartment having four corners, the compartment including a doorway disposed along one wall of the second pair of parallel walls and located substantially in a first corner; the locating the fire including locating the fire in the compartment in a second corner opposite to and diagonal to the doorway, the locating the fire including generating a substantially steady state fire size ranging from about 40 kW to about 750 kW; and
locating the sprinkler in the compartment so as to be above the fire.

24. The method of claim 23, wherein locating the fire includes igniting a propane burner disposed in the second corner having a propane gas supply with a propane flow control valve, an air supply with an air flow control valve, the igniting further including setting the propane and air flow control valves such that the steady state fire size is one of: 42 kW, 75 kW and 96 kW.

25. The method of claim 23, wherein determining the second mass flow profiles includes discharging water from the sprinkler in the actuated state at a delivery rate of about thirteen gallons per minute (13 GPM).

26. The method of claim 23, wherein determining at least one of the first and second mass flow profiles includes determining at least one of a pressure gradient and a temperature gradient across the doorway.

27. The method of claim 26, wherein determining that at least one of the first and second mass flow rates includes:
installing within the doorway a grid network of spaced apart pressure probes,
obtaining a differential pressure reading from each probe;
determining a calculated mass flux for each differential pressure reading;
linearly interpolating between each calculated mass flux; and
summating each of the calculated and linearly interpolated mass flux to determine respectively at least one of the first and second total mass flow rates in the doorway and the total flow out of the doorway.

28. The method of claim 23, wherein locating the sprinkler includes positioning the sprinkler such that when the sprinkler is in the actuated state, a discharge spray pattern from the sprinkler does not directly impact the doorway.

29. The method of claim 23, wherein locating the sprinkler includes positioning the sprinkler so as to define the location of the second neutral plane within the range along the vertical length.

30. The method of claim 23, wherein locating the fire includes locating a pre-mix fire such that when the sprinkler is in the actuated state, the steady state of the fire is maintained.

31. A method comprising:
locating a sprinkler in a compartment such that the location of a neutral plane in a pre-mixed fire induced mass flow profile over the vertical length of a doorway is substantially the same when the sprinkler is actuated and when the sprinkler is unactuated;
determining a ratio of the total mass flow from the doorway of the compartment induced by the pre-mixed fire and in the presence of the actuated sprinkler to the total mass flow from the doorway of the compartment induced by the fire and in the absence of the actuated sprinkler, the fire being steady state and ranging in size from about 40 kW to about 750 kW; and
modifying the following equation by the ratio to predict the mass flow from the doorway of the compartment in the presence of the actuated sprinkler
$${\dot{m}}_{out} = \frac{2}{3} {C}_{D} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2} ,$$
wherein
\dot{m}ₒᵤₜ is the mass flow out of the doorway;
CD is the doorway discharge coefficient;
W is the doorway width;
ρ_{∞} is the ambient density;
T_{∞} is the ambient temperature;
T_{G} is the gas temperature;
g is gravity;
H is the doorway height; and
Z_{N} is the neutral plane height.

32. A method of specifying the impact of an actuated sprinkler on a fire induced mass flow through a doorway of a compartment, the method comprising:
identifying a ratio of a fire induced mass flow from the compartment in the presence of the actuated sprinkler to a fire induced mass flow from the compartment in the absence of the actuated sprinkler; and
assigning the ratio as a-coefficient of the sprinkler.

33. The method of claim 32, further comprising correcting the following equation
$${\dot{m}}_{out} = \frac{2}{3} {C}_{D} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2} ,$$
wherein
\dot{m}ₒᵤₜ is the mass flow out of the doorway;
CD is the doorway discharge coefficient;
W is the doorway width;
ρ_{∞} is the ambient density;
T_{∞} is the ambient temperature;
T_{G} is the gas temperature;
g is gravity;
H is the doorway height; and
Z_{N} is the neutral plane height.

34. The method of claim 32, wherein identifying the ratio includes:
igniting a pre-mixed fire within the compartment;
growing the fire to a steady state in the absence of the actuated sprinkler;
flowing a first fire induced mass flow through the doorway rate so as to define a first fire induced mass rate profile having a neutral plane;
actuating the sprinkler within the compartment in the presence of the steady state fire;
flowing a second fire induced mass flow through the doorway so as to define a second fire induced mass flow profile having a neutral plane within an operational range of the neutral plane of the first fire induced mass flow profile;
determining the location of the neutral plane of the first fire induced mass flow profile;
determining the location of the neutral plane of the second fire induced mass flow profile;
determining a total mass flow of the first fire induced mass flow profile; and
determining a total mass flow of the second fire induced mass flow profile.

35. A method of classifying the mass flow effect of a sprinkler, the method comprising:
determining a-coefficient of the sprinkler; and
applying the-coefficient to the following equation
$${\dot{m}}_{out} = \frac{2}{3} {C}_{D} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2} ,$$
wherein
\dot{m}ₒᵤₜ is the mass flow out of the doorway;
CD is the doorway discharge coefficient;
W is the doorway width;
ρ_{∞} is the ambient density;
T_{∞} is the ambient temperature;
T_{G} is the gas temperature;
g is gravity;
H is the doorway height; and
Z_{N} is the neutral plane height.

36. A system for determining a sprinkler coefficient for a sprinkler having an unactuated and an actuated state, the sprinkler coefficient defining a ratio of a fire induced mass flow from a compartment having the sprinkler in the actuated state to a fire induced mass flow from the compartment with the sprinkler in the unactuated state, the system comprising:
a test compartment having a doorway with a vertical length;
a sprinkler installed within the compartment, the sprinkler including a control valve to selectively place the sprinkler in one of the actuated and unactuated states;
a burner for generating a pre-mixed fire within the test compartment in a location below the sprinkler and spaced from the sprinkler and the doorway so as to define a fire induced mass flow profile in the doorway, the profile being stratified so as to define a neutral plane along a range of the vertical length, the burner being configured to generate a fire size ranging from about 40 kW to about 750 kW; and
a plurality of sensors for determining at least one of a pressure and temperature differential across the doorway in the presence of the fire generated by the burner.

37. The system of claim 36, wherein the plurality of sensors include a grid network of differential pressure probes, the grid network being disposed within the doorway, the differential pressure probes being bi-directional and spaced throughout the network to determine the location of the neutral plane.

38. The system of claim 36, wherein the plurality of sensors include a plurality of thermocouples, the plurality of thermocouples including:
a first portion to measure an upper gas temperature within the compartment;
a second portion to measure a temperature proximate the differential pressure probes; and
a third portion to measure an ambient temperature outside the compartment.

39. The system of claim 36, wherein the sprinkler is installed in accordance with applicable NFPA 13 standards for the compartment so as to define a maximum spacing from the burner.

40. The system of claim of 39, wherein the standards define the minimum flow rate from the sprinkler when the sprinkler is in the actuated state.

41. The system of claim 36, wherein the burner includes a propane burner including a propane gas supply with a propane flow control valve and an air supply with an air flow control valve.

42. A coefficient of a sprinkler that converts a fire induced mass flow through a doorway of a compartment to a fire and sprinkler induced mass flow.

43. A coefficient of a sprinkler that coverts a theoretical fire induced mass flow through a doorway of a compartment to a fire and sprinkler water distribution induced mass flow from the doorway of the compartment.

44. A system to determine a fire induced mass flow from a doorway of a compartment with an actuated sprinkler in the compartment, the system comprising:
means for obtaining a fire induced mass flow from the doorway of the compartment without a sprinkler in the compartment; and
a coefficient that converts the fire induced mass flow to a fire and sprinkler water distribution induced mass flow from the doorway of the compartment.

45. The system of claim 44, wherein the means is experimental and comprises:
a test compartment having a doorway with a vertical length;
a burner for generating a fire within the test compartment in a location spaced from the doorway so as to define a fire induced mass flow profile in the doorway, the profile being stratified so as to define a neutral plane along a range of the vertical length, the burner being configured to generate a fire size ranging from about 40 kW to about 750 kW; and
a plurality of sensors for determining at least one of a pressure and temperature differential across the doorway in the presence of a fire generated by the burner.

46. The system of claim 44, wherein the means is at least partially theoretical and comprises:
$${\dot{m}}_{out} = \frac{2}{3} {C}_{D} W {ρ}_{∞} \sqrt{2 \frac{{T}_{∞}}{{T}_{G}} ( 1 - \frac{{T}_{∞}}{{T}_{G}} ) g} {( H - {Z}_{N} )}^{3 / 2} ,$$
wherein
\dot{m}ₒᵤₜ is the mass flow out of the doorway;
CD is the doorway discharge coefficient;
W is the doorway width;
ρ_{∞} is the ambient density;
T_{∞} is the ambient temperature;
T_{G} is the gas temperature;
g is gravity;
H is the doorway height; and
Z_{N} is the neutral plane height.
